(19) United States
(12) Patent Application Publication
(10) Pub. No.: US 2025/0066194 A1
(43) Pub. Date: Feb. 27, 2025

(54) SYSTEMS AND METHODS FOR HYDROGEN PLANT DRYER REGENERATION

(71) Applicant: Ohmium International, Inc., Newark, CA (US)

(72) Inventors: Arne Ballantine, Incline Village, CA (US); Tom Miller, San Jose, CA (US); Rasool Aghatehrani, Redwood City, CA (US); Chockkalingam Karuppaiah, Fremont, CA (US)

(21) Appl. No.: 18/814,278

(22) Filed: Aug. 23, 2024

Related U.S. Application Data
(60) Provisional application No. 63/534,704, filed on Aug. 25, 2023.
(60) Provisional application No. 63/534,701, filed on Aug. 25, 2023.

(51) Int. Cl. C01B 3/56; B01D 53/04; B01D 53/26; B01J 20/34; F04B 35/04; F04B 37/18

(52) U.S. Cl. CPC C01B 3/56; B01D 53/0446; B01D 53/261; B01J 20/3491; F04B 35/04; F04B 37/18; B01D 2256/16; B01D 2257/80; B01D 2259/40052; B01D 2259/40086; C01B 2203/043; C01B 2203/0495

(57) ABSTRACT

Systems and methods for regenerating dryers in processes for producing hydrogen are described. The systems and methods include regenerating the dryers either with hydrogen produced during the process or with an inert gas, such as nitrogen. The systems and methods increase utilization of hydrogen produced in the process and overall efficiency.

### CROSS-REFERENCE TO RELATED APPLICATIONS

This application claims priority to U.S. Provisional Application No. 63/534,704 titled “System and Methods for Hydrogen Plant Dryer Purging Using an Inert Gas System and Monitors” filed Aug. 25, 2023, and to U.S. Provisional Application No. 63/534,701 titled “Advanced Drying Concepts for Purification of Hydrogen Produced through Electrolysis” filed Aug. 25, 2023, the entire contents of each of which are incorporated by reference herein.

### FIELD OF THE DISCLOSURE

The present disclosure is directed systems and methods for regenerating dryers used in hydrogen production plants.

### BACKGROUND

A hydrogen plant includes drying equipment to remove H₂O and O₂ impurities prior to the outlet of the hydrogen plant to ensure outlet hydrogen remains pure for downstream use. To maintain constant hydrogen production a dual dryer system is often employed. While one dryer is in service, the other is isolated from the hydrogen flow and regenerated to prevent saturation of the dryer system. To ensure all contaminants are removed from the off-service dryer, pure hydrogen is used to purge the dryer and conduct the regeneration. This hydrogen is recirculated from the outlet of the in-service dryer, thereby reducing the amount of hydrogen available for downstream use. This purge flow of hydrogen can reduce the output by as much as 10% of the hydrogen produced.

To purge a dryer, hydrogen is generally taken from the outlet of an in-service dryer and redirected from the outlet of the hydrogen plant to be recirculated to the off-service dryer, and then vented to the atmosphere through a drainage system that mixes the hydrogen gas with ambient air or other inert gases through one or more fans to prevent hydrogen gas build up and fire or deflagration hazards. An inert gas may be used to purge the off-service dryer of moisture and then vented to atmosphere. This is repeated until the purge gas has reduced moisture and contaminants at acceptable levels. The dryer may also be purged through use of a low-pressure vacuum system and repressurized to a positive pressure using hydrogen or another inert gas. This cycle is repeated until the level of moisture and impurity is reduced to acceptable levels. In both of these options, hydrogen is required to repressurize the system before placing the dryer on service, thereby reducing overall system efficiency.

### SUMMARY

Provided herein are methods for regenerating an off-service dryer used in the production of hydrogen. The methods generally include producing low-pressure hydrogen; pressurizing the low-pressure hydrogen using one or more electrochemical hydrogen pumps to form high-pressure hydrogen; drying the high-pressure hydrogen in an on-service dryer to produce dried hydrogen; and purging the off-service dryer with a portion of the dried hydrogen. Further provided herein are systems for regenerating an off-service dryer used in the production of hydrogen. The systems generally include an off-service dryer fluidly connected to a water knock-out module, the off-service dryer providing low-pressure hydrogen to the water knock-out module; one or more electrochemical hydrogen pumps fluidly connected to the water knock-out module and to an on-service dryer, the one or more electrochemical hydrogen pumps pressurizing low-pressure hydrogen from the water knock-out module to form high pressure hydrogen, the on-service dryer receiving the high-pressure hydrogen from the one or more electrochemical hydrogen pumps; and the on-service dryer producing dried hydrogen and fluidly connected to the off-service dryer, the on-service dryer further providing a portion of the dried hydrogen to the off-service dryer.

Further provided herein are methods for regenerating an off-service dryer used in the production of hydrogen. The methods generally include purging the off-service dryer with an inert gas to dilute hydrogen contained in the off-service dryer; and separating the hydrogen from the inert gas in one or more electrochemical hydrogen pumps. In other embodiments, the methods include purging the off-service dryer with an inert gas to dilute hydrogen contained in the off-service dryer and venting the inert gas and the diluted hydrogen. Further provided herein are systems for regenerating an off-service dyer used in the production of hydrogen. The systems generally include an off-service dryer fluidly connected to an inert gas source and to one or more electrochemical hydrogen pumps, the off-service dryer receiving inert gas from the inert gas source to dilute hydrogen contained within the off-service dryer; and the one or more electrochemical hydrogen pumps fluidly connected to an on-service dryer, the one or more electrochemical hydrogen pumps separating the inert gas from the hydrogen. In other embodiments, the systems include an off-service dryer fluidly connected to an inert gas source, the off-service dryer receiving inert gas from the inert gas source to dilute hydrogen contained within the off-service dryer.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale. System components such as valves, sensors, and the like are not shown for the purposes of clarity, but those having ordinary skill in the art will appreciate that such components are present in the systems described herein.

FIG. 1 shows an example system 100 describing the state of the art.

FIGS. 2A-2C show various embodiments of the systems described herein for regenerating a dryer using hydrogen. FIG. 2A shows a system 200 wherein a blower 216 is used to recirculate low-pressure hydrogen (“LP H₂”) from an off-service dryer 210 and from one or more electrochemical hydrogen pumps 212 to a water knock-out module 214. FIG. 2B shows an embodiment where a venturi device 217 replaces the blower 216. FIG. 2C shows an embodiment wherein the one or more electrochemical hydrogen pumps 212 are “dead-ended”.

FIG. 3 shows a cascaded arrangement of the one or more electrochemical hydrogen pumps that may be used in the systems described herein.

FIGS. 4A and 4B show additional embodiments of the systems described herein for regenerating a dryer using an inert gas.

### DETAILED DESCRIPTION

The present disclosure is directed to systems and methods for purging and regenerating dryer systems used in the production of hydrogen, particularly in the production of hydrogen via electrolysis. The systems and methods described herein are cost-effective and improve hydrogen electrolyzer efficiency and improve utilization of hydrogen and water. The systems also reduce load on the dryer and water knock-out systems to increase overall system efficiency and extend operating cycle time of the dryer before it becomes saturated with water and requires regeneration.

### I. Systems and Methods for Dryer Regeneration Using Hydrogen

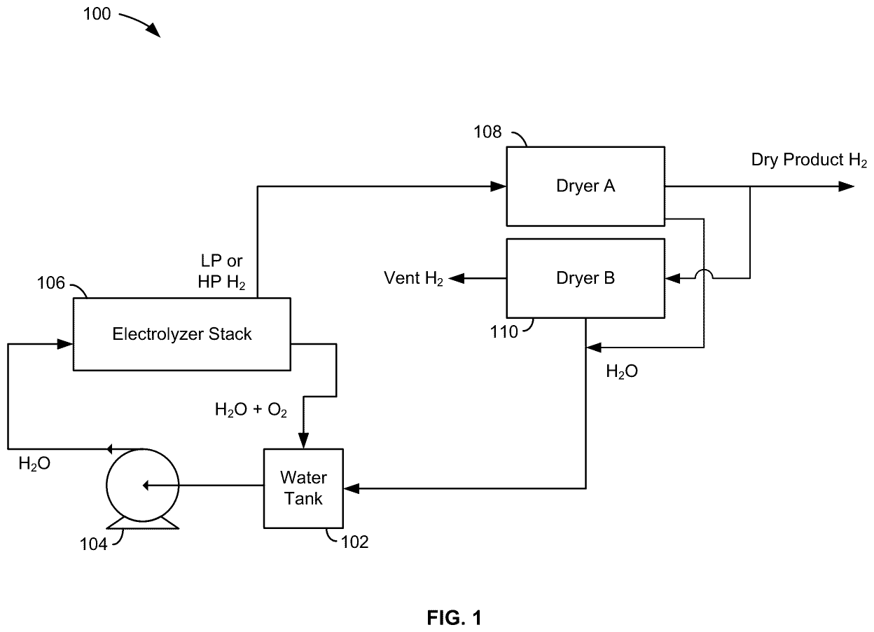

FIG. 1 shows an example system 100 describing the state of the art. The system 100 includes a water tank 102 that contains water for use in the electrolysis. The water in the water tank 102 is pumped using a pump 104 into the electrolyzer stack 106. The electrolyzer stack 106 electrolyzes the water to form hydrogen and oxygen gases. Most of any remaining water and the oxygen are separated from the hydrogen in the electrolyzer stack 106 and are directed to the water tank 102 for recycling. The hydrogen produced in the electrolyzer stack 106 may be high-pressure hydrogen (“HP H₂”) or low-pressure hydrogen. The hydrogen gas is directed to an on-service dryer 108 (labelled “Dryer A” in FIG. 1), which removes the water and other impurities remaining in the hydrogen gas. The water and other impurities are recycled to the water tank 102. Most of the dried hydrogen is then delivered directly to a hydrogen utilizer or stored as a product, while a portion of the dry hydrogen is directed to an off-service dryer 110 (labelled “Dryer B” in FIG. 1) to regenerate the dryer. The hydrogen gas, now having an increased water content from regenerating the dryer, is then diluted with ambient air before venting to the atmosphere. As noted above, this arrangement reduces overall hydrogen utilization of the system.

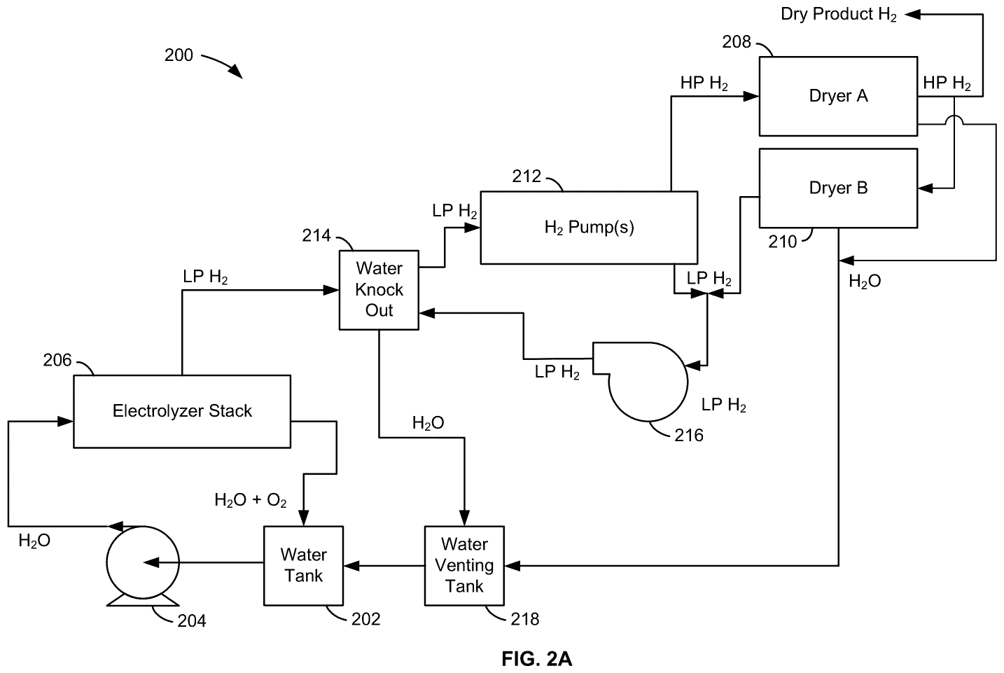

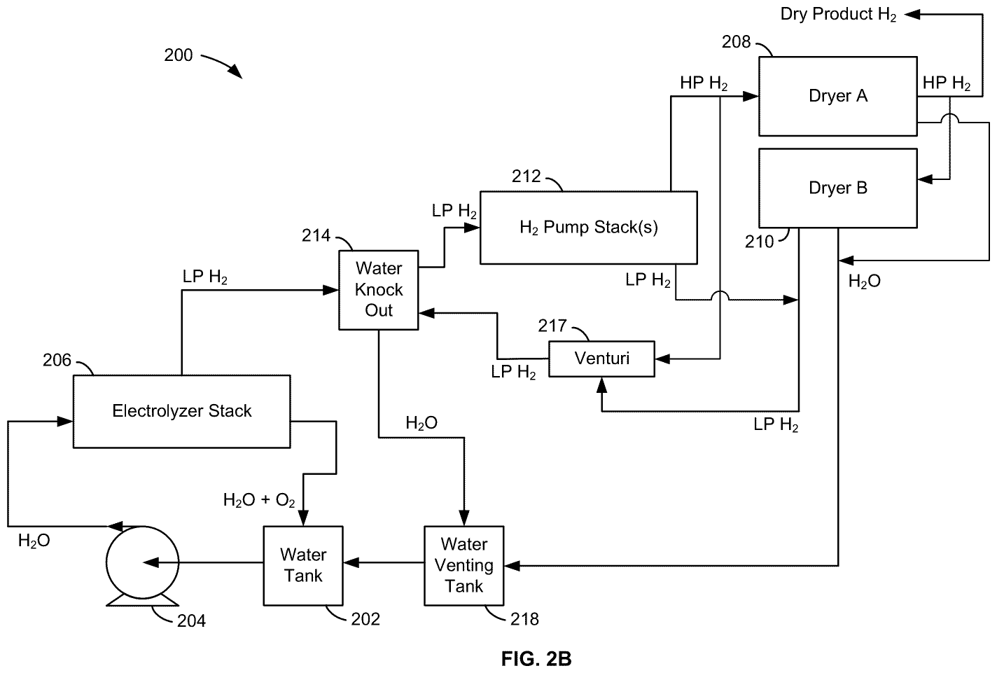

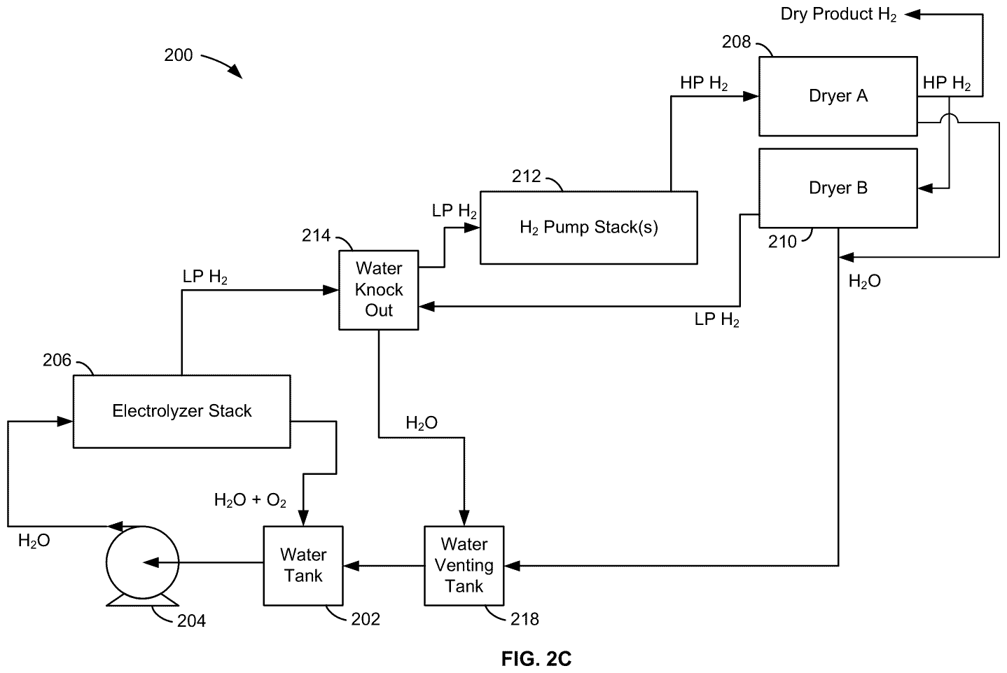

FIGS. 2A-2C show a system 200 of the present disclosure. With respect to FIG. 2A, the system 200 includes a main water tank 202 that contains water for use in the electrolysis. The water in the main water tank 202 is pumped using a pump 204 into the electrolyzer stack 206. The electrolyzer stack 206 electrolyzes the water to form hydrogen and oxygen gases. In this embodiment, the electrolyzer stack 206 is configured to produce low-pressure hydrogen gas. The low-pressure hydrogen gas is directed to a water knock-out module 214 that lowers the water content of the low-pressure hydrogen gas. The water removed from the low-pressure hydrogen gas is then optionally purified (not shown) and recycled to the main water tank 202. The low-pressure hydrogen gas is then directed to one or more electrochemical hydrogen pumps 212. The one or more electrochemical hydrogen pump 212 pressurizes the low-pressure hydrogen gas into high-pressure hydrogen gas. In this system 200, a portion of the low-pressure hydrogen gas does not pass through the one or more electrochemical hydrogen pumps 212 and is recirculated back to the water knock-out module 214 via a blower 216. The high-pressure hydrogen gas produced in the one or more electrochemical hydrogen pumps 212 is then sent to an on-service dryer 208 to remove additional water and impurities. The water and impurities may be optionally purified (not shown) and are recycled back to the main water tank 202. Most of the dried high-pressure hydrogen is sent to a hydrogen utilizer, while a portion of the dried high-pressure hydrogen is sent to an off-service dryer 210 to regenerate the off-service dryer. For example, about 8% to about 15%, such as about 10%, of the dry hydrogen stream may be directed to the off-service dryer 210. The high-pressure hydrogen gas is depressurized in the off-service dryer 210 to low-pressure hydrogen. The low-pressure hydrogen, now with an increased water content from regenerating the off-service dryer 210, is recycled back to the water knock-out module 214 via the blower 216. Accordingly, the system 200 massively increases the hydrogen utilization and water utilization as compared to the system 100 of FIG. 1.

The main water tank 202 may be any vessel suited to store water. Preferably, the main water tank 202 is constructed of materials that do not leach impurities into the water prior to electrolysis. The main water tank 202 is fluidly connected to the pump 204 such that the pump 204 may pull water from the main water tank 202 for electrolysis. The main water tank 202 includes a venting feature to allow oxygen produced in the electrolyzer and dissolved in the water to vent to the atmosphere.

The pump 204 may be any pump suitable for pumping water for use in electrolysis. The pump may be any pump known in the art, such as a centrifugal pump, diaphragm pump, gear pump, screw pump, peristaltic pump, and the like. Methods of sizing and procuring pumps suitable for use in the systems of the present disclosure will be known to those having ordinary skill in the art. The pump 204 is fluidly connected to the main water tank 202 and to the electrolyzer stack 206, such that the pump 204 is operable to pump water from the main water tank 202 to the electrolyzer stack 206.

The electrolyzer stack 206 may be any electrolyzer stack known in the art suitable for producing low-pressure hydrogen gas from water. Although only one electrolyzer stack 206 is shown, the electrolyzer stack 206 may include more than one electrolyzer stack connected in parallel. The electrolyzer stack 206 may include a proton-exchange membrane (PEM) electrolyzer stack, an anion-exchange membrane (AEM) electrolyzer stack, an alkaline electrolyzer stack, a solid-oxide electrolyzer stack, or any combination thereof.

Although the systems described herein involve production of hydrogen via electrolysis, it will be appreciated that the scope of the disclosure extends beyond systems for producing hydrogen via electrolysis and that the systems and methods described herein may be used in systems for producing hydrogen by other means.

The on-service dryer 208 and the off-service dryer 210 may each comprise a pressure swing adsorption (PSA) system, a temperature swing adsorption (TSA) system, or a hybrid PSA-TSA system, but preferably the on-service dryer 208 and the off-service dryer 210 are the same type of system. The dryer utilizes an adsorbent to remove water and other impurities from the hydrogen gas. The adsorbent may include a zeolite or a similar material (e.g., a metal organic framework), or other adsorbents known in the art. Both the on-service dryer 208 and the off-service dryer 210 may contain or may be fluidly connected to a phase separator to condense the water and other gases during the regeneration process, described in more detail below. It will be appreciated that although only a single on-service dryer 208 and off-service dryer 210 are shown in FIG. 2A, the system 200 may include multiple on-service dryers and multiple off-service dryers depending on the size and needs of the system.

The on-service dryer 208 further purifies the high-pressure hydrogen gas from the one or more electrochemical hydrogen pumps 212 such that it may be used by a hydrogen utilizer. The hydrogen utilizer may include system or process that utilizes hydrogen or a plurality of such systems or processes, such as storage, vehicle fuel, combustion fuel, electricity production, etc. The on-service dryer 208 is fluidly connected to the one or more electrochemical hydrogen pumps 212, to the hydrogen utilizer, and to the off-service dryer 210 such that the on-service dryer 208 is operable to remove water and other impurities from the high-pressure hydrogen produced by the one or more electrochemical hydrogen pumps 212 and deliver the dried high-pressure hydrogen to the hydrogen utilizer and to the off-service dryer 210.

As discussed in more detail below, a sensor (not shown) may be included at the outlet of the on-service dryer to measure the water content of the dried hydrogen. As the dryer becomes saturated, the water content of the dried hydrogen will increase. Once the water content reaches a predetermined threshold level, the on-service dryer 208 will be removed from service and will become the off-service dryer to be regenerated as described herein, and the off-service dryer 210 will be placed in service and become the on-service dryer.

The off-service dryer 210 receives a portion of the dried high-pressure hydrogen from the on-service dryer 208 to regenerate the adsorbent bed saturated with water and other impurities. The high-pressure hydrogen depressurizes to low-pressure hydrogen during this process. As the hydrogen passes through the adsorbent and removes water vapor and other impurities, the hydrogen becomes saturated with the water and other impurities. The saturated hydrogen may then pass through a phase separator (not shown) to condense the water and other impurities, which may then be optionally purified and sent to the main water tank 202. The phase separator may comprise a condenser, a phase separator, a microporous filter having a bubble pressure sufficient to condense the water, or other devices capable of condensing the water. Accordingly, the off-service dryer 210 is fluidly connected to the on-service dryer 208, the main water tank 202, and to the blower 216 such that the off-service dryer 210 is operable to receive dry high-pressure hydrogen from the on-service dryer 208, direct condensed water and impurities to the main water tank 202, and direct the low-pressure saturated hydrogen to the blower 216 to be recycled.

The one or more electrochemical hydrogen pumps 212 pressurize the low-pressure hydrogen to form high pressure hydrogen. The one or more electrochemical hydrogen pumps 212 may include a single electrochemical pump (i.e., a single membrane) or may include an electrochemical pump stack (i.e., multiple membranes arranged in a stack). Electrochemical pumps capable of pressurizing hydrogen and methods of making and procuring electrochemical hydrogen pumps are generally known in the art. Each of the one or more electrochemical hydrogen pumps 212 may include an outlet stream of low-pressure hydrogen that is not pressurized and is recirculated back to the water knock-out module 214. In other embodiments, as shown in FIG. 2C and discussed in more detail below, the one or more electrochemical hydrogen pumps 212 may be “dead-ended” and may not include a low-pressure hydrogen outlet stream.

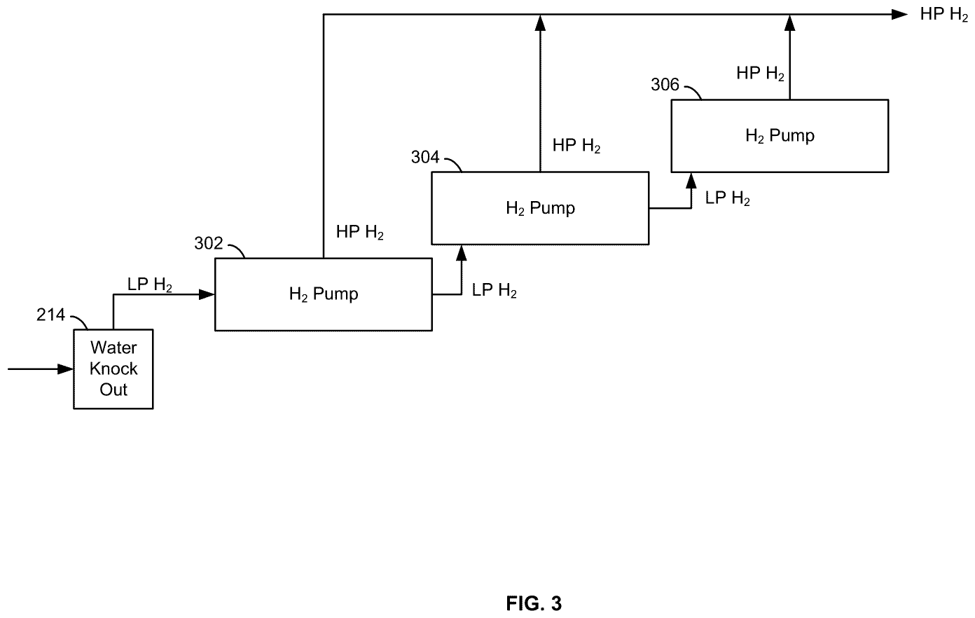

When a plurality of electrochemical hydrogen pumps is used, the electrochemical hydrogen pumps may be arranged in parallel orientation such that each electrochemical hydrogen pump receives low-pressure hydrogen from the water knock-out module 214 and delivers high-pressure hydrogen to the on-service dryer 208. In other embodiments, the plurality of electrochemical hydrogen pumps may be arranged in a cascade as shown in FIG. 3. In this arrangement, the low-pressure hydrogen is enters the first electrochemical hydrogen pump 302, which produces high-pressure hydrogen and remaining low-pressure hydrogen which fails to pass through the pump. The remaining low-pressure hydrogen is then directed to a second hydrogen pump 304 to produce additional high-pressure hydrogen. The remaining low-pressure hydrogen from the second hydrogen pump 304 is then directed to a third hydrogen pump 306 to form high-pressure hydrogen. The third hydrogen pump 306 may be dead-ended as shown in FIG. 3, or it may recirculate any remaining low-pressure hydrogen back to the water knock-out device 214. Each of the high-pressure hydrogen streams may be combined into a common header before being sent to the on-service dryer 208 (not shown in FIG. 3). It should be appreciated that while only three electrochemical hydrogen pumps are shown in FIG. 3, any number of hydrogen pumps may be used in the plurality of electrochemical hydrogen pumps. By using this cascade arrangement, most or all of the hydrogen is efficiently pressurized prior to drying in the on-service dryer 208. Although not shown in FIG. 3, hydrogen used to regenerate the off-service dryer 210 may be recycled to the water knock-out module 214 before entering the cascade.

The water knock-out module 214 removes water from the low-pressure hydrogen stream before the low-pressure hydrogen is pressurized in the one or more electrochemical hydrogen pumps 212. The water knock-out module 214 may include one or more devices other than a dryer as described above capable of lowering the water content of the low-pressure hydrogen. The water knock-out module 214 is fluidly connected to the electrolyzer stack 206 to receive low-pressure hydrogen, to the one or more electrochemical hydrogen pumps 212, and to the blower 216 to receive low-pressure hydrogen from the one or more electrochemical hydrogen pumps 212 and from the off-service dryer 210. In an embodiment, the water knock-out module includes a chamber having baffles designed to reduce the flow rate of the low-pressure hydrogen. As the low-pressure hydrogen flows against the baffles, the water vapor trapped in the low-pressure hydrogen condenses and collects in the chamber. In another embodiment, the water knock-out module 214 may include a pressure expander, a condenser, a phase separator, a microporous filter having a bubble pressure sufficient to condense the water, or other devices capable of condensing the water vapor.

The water removed from the hydrogen gas via the water knock-out module 214 is optionally purified (not shown) and is sent to a water venting tank 218. The water venting tank 218 may be any vessel suited to store water. Preferably, the water venting tank 218 is constructed of materials that do not leach impurities into the water prior to electrolysis. The water venting tank 218 includes a venting feature to allow any hydrogen dissolved in the water to vent to the atmosphere. The water may then be optionally purified and sent to the main water tank 202 to be used for electrolysis, thereby increasing water utilization of the system 200.

The blower 216 may be any blower known in the art. The blower 216 recirculates low-pressure hydrogen from the off-service dryer 210 and from the one or more electrochemical hydrogen pumps 212 to the water knock-out module 214, and therefore is fluidly connected to the off-service dryer 210, the water knock-out module 214, and to the one or more electrochemical hydrogen pumps 212.

In another embodiment, such as that shown in FIG. 2B, a venturi device 217 may be used in place of the blower 216. Venturi devices and methods of making and using the same are generally known in the art. The venturi device 217 is fluidly connected to the one or more electrochemical hydrogen pumps 212, the off-service dryer 210, and to the water knock-out module 214. In this embodiment, the outlet of the one or more electrochemical hydrogen pumps 212 is bifurcated, with one stream of high-pressure hydrogen entering the on-service dryer 208 and the other stream of hydrogen entering the venturi device 217. The low-pressure hydrogen from the one or more electrochemical hydrogen pumps 212 and the off-service dryer 210 enters the venturi through a side flow port and is entrained to the outlet of the venturi device 217 before reentering the water knock-out device 214. This embodiment increases overall energy efficiency of the system because the high-pressure hydrogen entering the venturi device 217 creates a suction force that forces the low-pressure hydrogen entering the side port of the venturi device 217 to the water knock-out module 214.

In yet another embodiment, such as that shown in FIG. 2C, the one or more electrochemical hydrogen pumps 212 may be “dead-ended” wherein there is no flow path for low-pressure hydrogen that does not pass through the electrochemical hydrogen pumps initially. Because of this, the embodiment of FIG. 2C does not include a direct recirculation loop from the one or more electrochemical hydrogen pumps 212 to the water knock-out module 214 as shown in the embodiments of FIGS. 2A and 2B. However, the off-service dryer 210 is fluidly connected to the water knock-out module 214 to recirculate the hydrogen used to regenerate the off-service dryer 210 to the water knock-out module 214.

A number of sensors may be placed throughout the system 200 to measure the purity of the hydrogen gas. One or more sensors may be placed at the outlet stream of the off-service dryer 210 to determine whether the dryer is purged and/or regenerated. For example, a dew point sensor may be used to determine the fraction of water in the gas leaving the off-service dryer 212. An oxygen sensor may be used to determine the oxygen content of the gas leaving the off-service dryer 212. Such sensors and methods of making and procuring the same are generally known in the art.

Additionally, one or more sensors may be placed at the outlet of the on-service dryer 208 to measure the purity of the hydrogen to be stored or sent to a hydrogen utilizer. For example, a dew point sensor may be used to determine the fraction of water in the gas leaving the on-service dryer 208. An oxygen sensor may be used to determine the oxygen content of the gas leaving the on-service dryer 208.

In a preferred embodiment, potentiostatic sensors are placed at the outlet of the on-service dryer 208 and at the outlet of the one or more electrochemical hydrogen pumps 212. The poetentiostatic sensors measure the potential difference between the hydrogen gas at the outlet of the on-service dryer 208 and at the outlet of the one or more electrochemical hydrogen pumps 212, wherein the difference in the potential indicates the amount of impurities in the gas being released from the on-service dryer 208.

The measurements made by the sensors may be transmitted to a controller. Based on the measurements made, the controller is operable to bypass the one or more electrochemical hydrogen pumps and place an off-service dryer on-service, or the controller may remove an on-service dryer from service for regeneration. This may be accomplished by the use of one or more valves such as a solenoid valve to start or stop flow of gas leaving the dryer from entering the one or more electrochemical hydrogen pumps 212.

As an example, when the hydrogen gas leaving an on-service dryer is measured to have a water content above a pre-determined threshold, the controller may open or close the one or more valves to prevent the hydrogen gas from being stored or sent to a hydrogen utilizer and sent instead to the one or more electrochemical hydrogen pumps for pressurization and additional water knock-out. The on-service dryer is then taken off-service for regeneration. Once the now off-service dryer is purged with hydrogen gas from the other on-service dryer and the water content of the inert gas leaving the now off-service dryer is measured to have a water content below a pre-determined threshold, the controller may open or close the one or more valves to bring the off-service dryer on-service, and provide the hydrogen for storage or to a hydrogen utilizer.

Further provided herein are methods of regenerating an off-service dryer used in a hydrogen production process. The methods may utilize the systems described hereinabove. The methods generally comprise producing low-pressure hydrogen; pressurizing the low-pressure hydrogen using one or more electrochemical hydrogen pumps to form high-pressure hydrogen; drying the high-pressure hydrogen in an on-service dryer; and purging the off-service dryer with a portion of the dried hydrogen.

The method may include the use of a single electrochemical hydrogen pump, while other aspects include the use of a plurality of electrochemical hydrogen pumps. When a plurality of electrochemical hydrogen pumps is used, each electrochemical hydrogen pump in the plurality of electrochemical hydrogen pumps may include a high-pressure hydrogen outlet stream and a low pressure hydrogen outlet stream. Each of the high-pressure hydrogen streams in the plurality of electrochemical hydrogen pumps may be connected to a common header which is fluidly connected to the on-service dryer. In another embodiment, each of the low-pressure hydrogen streams in the plurality of electrochemical hydrogen pumps may be directed into the next electrochemical hydrogen pump in the plurality of electrochemical hydrogen pumps (i.e., connected in series) until the last electrochemical hydrogen pump in the plurality of electrochemical hydrogen pumps is reached. The last electrochemical hydrogen pump in the series may be “dead-ended” and not allow any hydrogen to exit the electrochemical hydrogen pump until it passes through the membrane.

The dried hydrogen used to purge the off-service dryer may be depressurized to low-pressure hydrogen during the purging. The low-pressure hydrogen may be recirculated from the off-service dryer to a water knock-out module to remove excess water from the low-pressure hydrogen. As noted above, the recirculating may be accomplished via a blower or a venturi device. When a venturi device is used, the method may further comprise recirculating a portion of the high-pressure hydrogen formed in the one or more electrochemical hydrogen pumps to the venturi device. After removing excess water in the water knock-out module, the low-pressure hydrogen may be recirculated to the one or more electrochemical hydrogen pumps to repeat the pressurizing step.

The one or more hydrogen pumps may form an output stream of low-pressure hydrogen that does not pass through the electrochemical hydrogen pumps. This output stream of low-pressure hydrogen may be recirculated to a water knock-out module to remove excess water before it is recirculated back through the one or more electrochemical hydrogen pumps. Alternatively, the one or more electrochemical hydrogen pumps may be “dead-ended” and thus may not form a stream of low pressure hydrogen.

### II. Systems and Methods for Dryer Regeneration Using an Inert Gas

Further provided herein are systems and methods for dryer regeneration in a hydrogen production system using an inert gas.

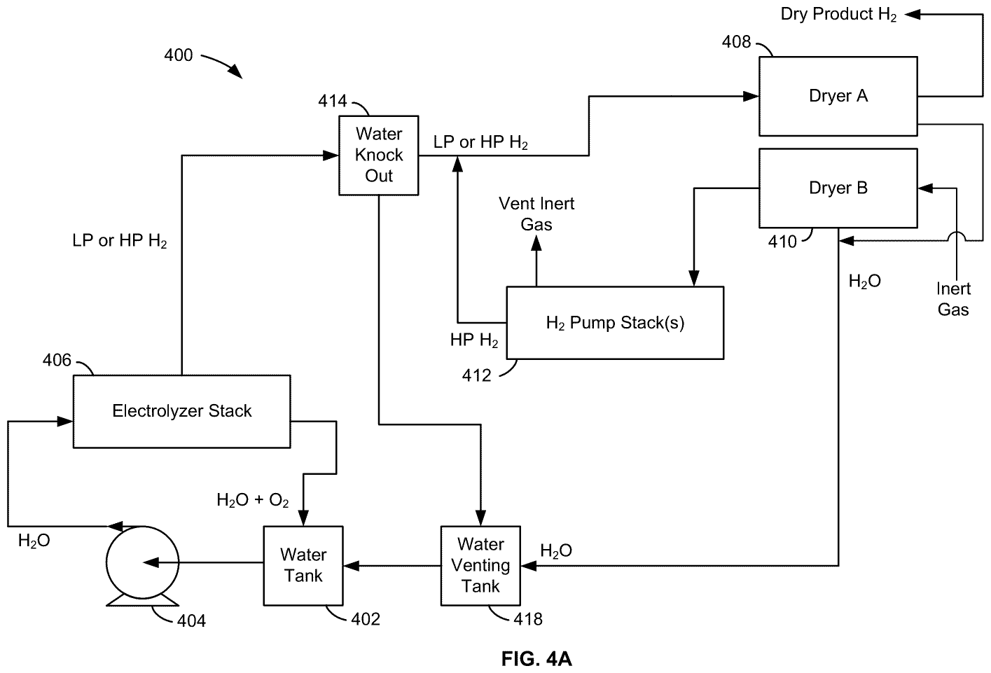

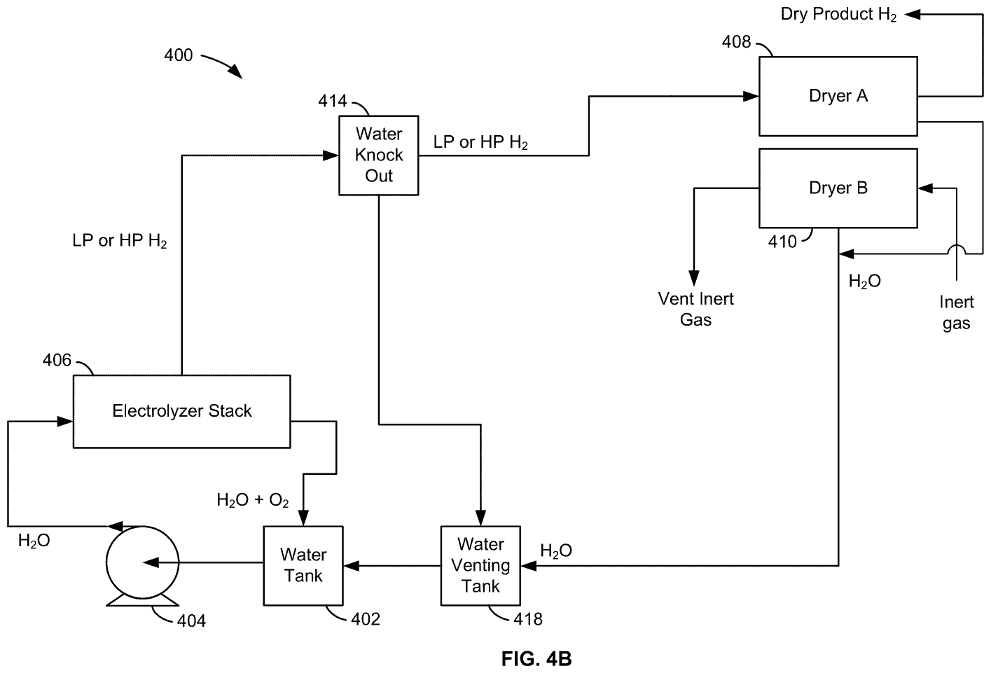

Turning to FIG. 4A, the system 400 includes a main water tank 402 that contains water for use in the electrolysis. The water in the main water tank 402 is pumped using a pump 404 into the electrolyzer stack 406. The water tanks, pumps, and electrolyzer stacks may be the same as those described in Section I above with regard to the systems shown in FIGS. 2A-2C. The electrolyzer stack 206 electrolyzes the water to form hydrogen and oxygen gases. The electrolyzer stack 406 may be configured to produce low-pressure hydrogen gas or high-pressure hydrogen gas. The low hydrogen gas is directed to a water knock-out module 414 that lowers the water content of the hydrogen gas. The water knock-out module may the same as those described in Section I above with regard to the systems shown in FIGS. 2A-2C. The hydrogen is then sent to an on-service dryer 408 where it is dried and then stored or sent to a hydrogen utilizer. An off-service dryer 410 is fluidly connected to one or more electrochemical hydrogen pumps 412. The on-service dryer 408, the off-service dryer 410, and the one or more electrochemical hydrogen pumps 412 may be the same as those described in Section I above with regard to the systems shown in FIGS. 2A-2C.

An inert gas is fed to the off-service dryer 410 to purge the off-service dryer 410 of hydrogen gas and to regenerate the off-service dryer 410. The inert gas may include nitrogen, argon, carbon dioxide, or another inert gas or a combination thereof. The inert gas is fed into the off-service dryer 410 to remove purge the dryer of hydrogen, which is then separated and recirculated when pressurized in the one or more electrochemical hydrogen pumps 412.

Initially, the flow of the inert gas for purging the off-service dryer 410 may be of a low quality and may include some water content; however, those having skill in the art will appreciate that high quality (i.e., substantially low or zero water content) may be used to regenerate the off-service dryer 410 efficiently and to remove all residual impurities from the off-service dryer 410.

The water removed from the hydrogen gas via the water knock-out module 414 is optionally purified (not shown) and is sent to a water venting tank 418. The water may then be optionally purified and sent to the main water tank 402 to be used for electrolysis, thereby increasing water utilization of the system 400. The water venting tank 418 may be any water venting tank described in Section I above.

A number of sensors may be placed throughout the system 400 to measure the purity of the hydrogen gas. One or more sensors may be placed at the outlet stream of the off-service dryer 410 to determine whether the dryer is purged and/or regenerated. For example, a dew point sensor may be used to determine the fraction of water in the gas leaving the off-service dryer 412. An oxygen sensor may be used to determine the oxygen content of the gas leaving the off-service dryer 412. Such sensors and methods of making and procuring the same are generally known in the art.

Additionally, one or more sensors may be placed at the outlet of the on-service dryer 408 to measure the purity of the hydrogen to be stored or sent to a hydrogen utilizer. For example, a dew point sensor may be used to determine the fraction of water in the gas leaving the on-service dryer 408. An oxygen sensor may be used to determine the oxygen content of the gas leaving the on-service dryer 408.

In a preferred embodiment, potentiostatic sensors are placed at the outlet of the on-service dryer 408 and at the outlet of the one or more electrochemical hydrogen pumps 412. The poetentiostatic sensors measure the potential difference between the hydrogen gas at the outlet of the on-service dryer 408 and at the outlet of the one or more electrochemical hydrogen pumps 412, wherein the difference in the potential indicates the amount of impurities in the gas being released from the on-service dryer 408.

The measurements made by the sensors may be transmitted to a controller. Based on the measurements made, the controller is operable to bypass the one or more electrochemical hydrogen pumps and place an off-service dryer on-service, or the controller may remove an on-service dryer from service for regeneration. This may be accomplished by the use of one or more valves such as a solenoid valve to start or stop flow of gas leaving the dryer from entering the one or more electrochemical hydrogen pumps 412.

As an example, when the hydrogen gas leaving an on-service dryer is measured to have a water content above a pre-determined threshold, the controller may open or close the one or more valves to prevent the hydrogen gas from being stored or sent to a hydrogen utilizer and sent instead to the one or more electrochemical hydrogen pumps for pressurization and additional water knock-out. The on-service dryer is then taken off-service for regeneration. Once the now off-service dryer is purged with the inert gas and the water content of the inert gas leaving the off-service dryer is measured to have a water content below a pre-determined threshold, the controller may open or close the one or more valves to allow the flow of hydrogen back into the one or more electrochemical hydrogen pumps. When the gas leaving the off-service dryer is measured to have an inert gas content and the water content is below a predetermined threshold, the controller may open or close the one or more valves to bypass one or more electrochemical hydrogen pumps, bring the off-service dryer on-service, and provide the hydrogen for storage or to a hydrogen utilizer.

In some embodiments, the gas purged from the off-service dryer 408 may be provided directly to a Haber-Bosch reactor for the production of ammonia. This is particularly useful when the inert gas used to purge the dryer is nitrogen. In such embodiments, the nitrogen gas and the hydrogen gas recovered in the one or more electrochemical hydrogen pumps 412 may be provided directly to the Haber Bosch reactor rather than being recirculated or vented.

An isotope marker may also be used to determine the nitrogen introduced from the purge of the dryer and the nitrogen sent directly to the Haber-Bosch reactor for ammonia synthesis. The isotope may be injected into the gas purged from the off-service dryer 408 and provided to the Haber-Bosch reactor. The ammonia synthesized in the Haber-Bosch reactor may then be analyzed for the isotope to determine the amount of the nitrogen from the off-service dryer 408 that was utilized in the Haber-Bosch reactor. For example, the isotope may be an isotope of hydrogen (e.g., deuterium or tritium) or nitrogen (e.g., ¹⁵N or ¹⁶N) which is then incorporated into the ammonia produced in the Haber-Bosch reactor.

In another embodiment, shown in FIG. 4B, the one or more electrochemical hydrogen pumps 412 is not included and the inert gas may be diluted prior to venting to the atmosphere. After the dryer is regenerated, it may be placed back into service by using hydrogen to purge and vent the inert gas from the off-service dryer until a sufficient quality of hydrogen gas is reached at the outlet of the off-service dryer, at which point the off-service dryer may be brought back on-service and the hydrogen may be provided to a hydrogen utilizer or stored.

Although the systems described herein involve production of hydrogen via electrolysis, it will be appreciated that the scope of the disclosure extends beyond systems for producing hydrogen via electrolysis and that the systems and methods described herein may be used in systems for producing hydrogen by other means.

Further provided herein are methods for regenerating an off-service dryer used in the production of hydrogen using an inert gas. The methods generally comprise purging the off-service dryer with an inert gas to dilute hydrogen contained in the off-service dryer; providing the inert gas from the dryer to an electrochemical hydrogen pump; and separating the hydrogen from the inert gas in one or more electrochemical hydrogen pumps. The separated hydrogen may be provided to a

The methods may further include stopping the purging of off-service dryer; directing a stream of high-pressure hydrogen into the off-service dryer; and directing the high-pressure hydrogen from the off-service dryer to the one or more electrochemical hydrogen pumps. The high-pressure hydrogen may be dried hydrogen produced in an on-service dryer.

The methods may further include measuring the amounts of impurities (i.e., the concentration of impurities) in the high-pressure hydrogen from the off-service dryer. The impurities may include oxygen content, water content, inert gas content, and other impurities. The impurities may be measured using one or more sensors as described above. The methods may then further include stopping directing the high-pressure hydrogen from the off-service dryer to the one or more electrochemical hydrogen pumps after the amount of impurities in the high-pressure hydrogen reaches a predetermined level. The predetermined level may reached when substantially no inert gas (i.e., less than 10 ppm) and substantially no water (i.e., less than 10 ppm) is detected in the high-pressure hydrogen.

Further provided herein is a method for regenerating an off-service dryer used in the production of hydrogen. The method may include purging the off-service dryer with an inert gas to dilute hydrogen contained in the off-service dryer and venting the inert gas and the diluted hydrogen. A buffer tank may be included to collect the hydrogen and the inert gas before venting to ensure that the hydrogen is sufficiently diluted to prevent deflagration and other hazards.

The methods may further include stopping the purging of the off-service dryer. This may occur when the water and hydrogen content of the inert gas from the outlet of the off-service dryer reaches a predetermined threshold level indicating that the off-service dryer has been sufficiently purged of hydrogen and of water. The water and hydrogen content of the inert gas may be measured using any one of the sensors described above.

Once the off-service dryer is regenerated, the method may further include directing a stream of high-pressure hydrogen into the off-service dryer. The high-pressure hydrogen may be dried hydrogen produced in an on-service dryer. The amount of impurities in the high-pressure hydrogen from the off-service dryer may be measured. Once the inert gas content and the water content of the high-pressure hydrogen reaches a predetermined threshold, the high-pressure hydrogen may be directed to a hydrogen utilizer or may be stored for later use.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

As used herein, the terms “including,” “containing,” and/or “having” are understood to mean comprising, and are open ended terms.

The indefinite articles “a” and “an,” as used herein in the specification and in the claims, unless clearly indicated to the contrary, should be understood to mean “at least one.”

As used herein, “high-pressure hydrogen” is defined as hydrogen gas having a pressure from greater than about 10 bar to about 50 bar.

As used herein, “low-pressure hydrogen” is defined as hydrogen gas having a pressure of up to about 10 bar.

As used herein, an “on-service” dryer is defined as a dryer that is actively providing dried hydrogen gas to a hydrogen utilizer or for storage. In contrast, an “off-service” dryer is defined as a dryer that is not actively providing dried hydrogen gas to a hydrogen utilizer or for storage, and that may be undergoing regeneration.

### ENUMERATED EMBODIMENTS

Embodiment 1: A method for regenerating an off-service dryer used in the production of hydrogen comprising:
producing low-pressure hydrogen;
pressurizing the low-pressure hydrogen using one or more electrochemical hydrogen pumps to form high-pressure hydrogen;
drying the high-pressure hydrogen in an on-service dryer to produce dried hydrogen; and
purging the off-service dryer with a portion of the dried hydrogen.

Embodiment 2: The method of embodiment 1, wherein the dried hydrogen used to purge the off-service dryer is depressurized to low-pressure hydrogen during the purging.

Embodiment 3: The method of embodiment 2, further comprising recirculating the low-pressure hydrogen from the off-service dryer to a water knock-out module.

Embodiment 4: The method of embodiment 3, wherein the recirculating is accomplished via a blower.

Embodiment 5: The method of embodiment 3, wherein the recirculating is accomplished via a venturi device.

Embodiment 6: The method of embodiment 5, further comprising recirculating a portion of the high-pressure hydrogen formed in the one or more electrochemical hydrogen pumps to the venturi device.

Embodiment 7: The method of any one of embodiments 3-6, wherein the low-pressure hydrogen in the water knock-out module is then recirculated to the one or more electrochemical hydrogen pumps to repeat the pressurizing step.

Embodiment 8: The method of any one of embodiments 1-7, wherein the one or more electrochemical hydrogen pumps forms an output stream of low-pressure hydrogen.

Embodiment 9: The method of embodiment 8, wherein the output stream of low-pressure hydrogen is recirculated to the one or more electrochemical hydrogen pumps.

Embodiment 10: The method of any one of embodiments 1-7, wherein the one or more electrochemical hydrogen pumps does not form a stream of low pressure hydrogen.

Embodiment 11: The method of any one of embodiments 1-10, wherein the one or more electrochemical hydrogen pumps comprises a plurality of electrochemical hydrogen pumps.

Embodiment 12: The method of embodiment 11, wherein each electrochemical hydrogen pump in the plurality of electrochemical hydrogen pumps comprises a high-pressure hydrogen stream and a low pressure hydrogen stream.

Embodiment 13: The method of embodiment 12, wherein each of the high-pressure hydrogen streams in the plurality of electrochemical hydrogen pumps is fluidly connected to a common header which is fluidly connected to the on-service dryer.

Embodiment 14: The method of embodiment 12 or 13, wherein each low-pressure hydrogen stream in the plurality of electrochemical hydrogen pumps is directed into the next electrochemical hydrogen pump in the plurality of electrochemical hydrogen pumps until the last electrochemical hydrogen pump in the plurality of electrochemical hydrogen pumps is reached.

Embodiment 15: The method of embodiment 14, wherein the last electrochemical hydrogen pump in the plurality of electrochemical hydrogen pumps does not form a low-pressure hydrogen stream.

Embodiment 16: The method of embodiment 14, wherein the last electrochemical hydrogen pump in the plurality of electrochemical hydrogen pumps also forms a low-pressure hydrogen stream that is recirculated through the plurality of electrochemical hydrogen pumps.

Embodiment 17: A system for regenerating an off-service dryer used in the production of hydrogen comprising:
an off-service dryer fluidly connected to a water knock-out module, the off-service dryer providing low-pressure hydrogen to the water knock-out module;
one or more electrochemical hydrogen pumps fluidly connected to the water knock-out module and to an on-service dryer, the one or more electrochemical hydrogen pumps pressurizing low-pressure hydrogen from the water knock-out module to form high pressure hydrogen, the on-service dryer receiving the high-pressure hydrogen from the one or more electrochemical hydrogen pumps; and
the on-service dryer producing dried hydrogen and fluidly connected to the off-service dryer, the on-service dryer further providing a portion of the dried hydrogen to the off-service dryer.

Embodiment 18: The system of embodiment 17, further comprising a blower fluidly connected to the off-service dryer and to the water knock-out module, the blower pumping low-pressure hydrogen from the off-service dryer to the water knock-out module.

Embodiment 19: The system of embodiment 17, further comprising a venturi device fluidly connected to the off-service dryer, the one or more electrochemical hydrogen pumps, and to the water knock-out module, the venturi device pumping the high-pressure hydrogen from the one or more electrochemical hydrogen pumps and low-pressure hydrogen from the off-service dryer to the water knock-out module.

Embodiment 20: The system of any one of embodiments 17-19, wherein the one or more electrochemical hydrogen pumps produces a stream of low-pressure hydrogen.

Embodiment 21: The system of any one of embodiments 17-19, wherein the one or more electrochemical hydrogen pumps does not produce a stream of low-pressure hydrogen.

Embodiment 22: The system of any one of embodiments 17-21, wherein the one or more electrochemical hydrogen pumps is a single electrochemical hydrogen pump.

Embodiment 23: The system of any one of embodiments 17-21, wherein the one or more electrochemical hydrogen pumps is a plurality of hydrogen pumps.

Embodiment 24: The system of embodiment 23, wherein the plurality of electrochemical hydrogen pumps is arranged in a cascade.

Embodiment 25: The system of embodiment 24, further comprising a common header fluidly connected to each of the electrochemical hydrogen pumps in the plurality of hydrogen pumps and to the on-service dryer, the common header providing high-pressure hydrogen from the plurality of electrochemical hydrogen pumps to the on-service dryer.

Embodiment 26: The system of any one of embodiments 17-25, further comprising a common header fluidly connected to each of the electrochemical hydrogen pumps in the plurality of hydrogen pumps and to the on-service dryer, the common header providing high-pressure hydrogen from the plurality of electrochemical hydrogen pumps to the on-service dryer.

Embodiment 27: A method for regenerating an off-service dryer used in the production of hydrogen comprising:
purging the off-service dryer with an inert gas to dilute hydrogen contained in the off-service dryer; and
separating the hydrogen from the inert gas in one or more electrochemical hydrogen pumps.

Embodiment 28: The method of embodiment 27, further comprising
stopping the purging of the off-service dryer;
directing a stream of high-pressure hydrogen into the off-service dryer; and
directing the high-pressure hydrogen from the off-service dryer to the one or more electrochemical hydrogen pumps.

Embodiment 29: The method of embodiment 28, further comprising measuring the amounts of impurities in the high-pressure hydrogen from the off-service dryer.

Embodiment 30: The method of embodiment 29, further comprising stopping directing the high-pressure hydrogen from the off-service dryer to the one or more electrochemical hydrogen pumps after the amount of impurities in the high-pressure hydrogen reaches a predetermined level; and directing the high pressure hydrogen to a hydrogen utilizer.

Embodiment 31: The method of embodiment 30, wherein the predetermined level is reached when substantially no inert gas is detected in the high-pressure hydrogen.

Embodiment 32: The method of embodiment 30 or 31, wherein the amount of impurities is determined via a potentiostatic sensor.

Embodiment 33: The method of any one of embodiments 27-32, wherein the inert gas comprises nitrogen, argon, or carbon dioxide.

Embodiment 34: The method of embodiment 33, wherein the inert gas comprises nitrogen.

Embodiment 35: A method for regenerating an off-service dryer used in the production of hydrogen comprising:
purging the off-service dryer with an inert gas to dilute hydrogen contained in the off-service dryer; and
venting the inert gas and the diluted hydrogen.

Embodiment 36: The method of embodiment 35, further comprising stopping the purging of the off-service dryer when the water and hydrogen content of the inert gas from the outlet of the off-service dryer reaches a predetermined threshold level.

Embodiment 37: The method of embodiment 36, further comprising directing a stream of high-pressure hydrogen into the off-service dryer.

Embodiment 38: The method of embodiment 37, further comprising
measuring the amount of impurities in the high-pressure hydrogen from the off-service dryer; and
directing the high-pressure hydrogen to a hydrogen utilizer after the amount of impurities in the high-pressure hydrogen reaches a predetermined level.

Embodiment 39: A system for regenerating an off-service dryer used in the production of hydrogen comprising:
an off-service dryer fluidly connected to an inert gas source and to one or more electrochemical hydrogen pumps, the off-service dryer receiving inert gas from the inert gas source to dilute hydrogen contained within the off-service dryer; and
the one or more electrochemical hydrogen pumps fluidly connected to an on-service dryer, the one or more electrochemical hydrogen pumps separating the inert gas from the hydrogen.

Embodiment 40: A system for regenerating an off-service dryer used in the production of hydrogen comprising an off-service dryer fluidly connected to an inert gas source, the off-service dryer receiving inert gas from the inert gas source to dilute hydrogen contained within the off-service dryer.

What is claimed is:

1. A method for regenerating an off-service dryer used in the production of hydrogen comprising:
producing low-pressure hydrogen;
pressurizing the low-pressure hydrogen using one or more electrochemical hydrogen pumps to form high-pressure hydrogen;
drying the high-pressure hydrogen in an on-service dryer to produce dried hydrogen; and
purging the off-service dryer with a portion of the dried hydrogen.

2. The method of claim 1, wherein the dried hydrogen used to purge the off-service dryer is depressurized to low-pressure hydrogen during the purging.

3. The method of claim 2, further comprising recirculating the low-pressure hydrogen from the off-service dryer to a water knock-out module.

4. The method of claim 3, wherein the recirculating is accomplished via a blower.

5. The method of claim 3, wherein the recirculating is accomplished via a venturi device.

6. The method of claim 5, further comprising recirculating a portion of the high-pressure hydrogen formed in the one or more electrochemical hydrogen pumps to the venturi device.

7. The method of claim 3, wherein the low-pressure hydrogen in the water knock-out module is then recirculated to the one or more electrochemical hydrogen pumps to repeat the pressurizing step.

8. The method of claim 1, wherein the one or more electrochemical hydrogen pumps forms an output stream of low-pressure hydrogen.

9. The method of claim 8, wherein the output stream of low-pressure hydrogen is recirculated to the one or more electrochemical hydrogen pumps.

10. The method of claim 1, wherein the one or more electrochemical hydrogen pumps does not form a stream of low pressure hydrogen.

11. The method of claim 1, wherein the one or more electrochemical hydrogen pumps comprises a plurality of electrochemical hydrogen pumps.

12. The method of claim 11, wherein each electrochemical hydrogen pump in the plurality of electrochemical hydrogen pumps comprises a high-pressure hydrogen stream and a low pressure hydrogen stream.

13. The method of claim 12, wherein each of the high-pressure hydrogen streams in the plurality of electrochemical hydrogen pumps is fluidly connected to a common header which is fluidly connected to the on-service dryer.

14. The method of claim 12, wherein each low-pressure hydrogen stream in the plurality of electrochemical hydrogen pumps is directed into the next electrochemical hydrogen pump in the plurality of electrochemical hydrogen pumps until the last electrochemical hydrogen pump in the plurality of electrochemical hydrogen pumps is reached.

15. The method of claim 14, wherein the last electrochemical hydrogen pump in the plurality of electrochemical hydrogen pumps does not form a low-pressure hydrogen stream.

16. The method of claim 14, wherein the last electrochemical hydrogen pump in the plurality of electrochemical hydrogen pumps also forms a low-pressure hydrogen stream that is recirculated through the plurality of electrochemical hydrogen pumps.

17. A system for regenerating an off-service dryer used in the production of hydrogen comprising:
an off-service dryer fluidly connected to a water knock-out module, the off-service dryer providing low-pressure hydrogen to the water knock-out module;
one or more electrochemical hydrogen pumps fluidly connected to the water knock-out module and to an on-service dryer, the one or more electrochemical hydrogen pumps pressurizing low-pressure hydrogen from the water knock-out module to form high pressure hydrogen, the on-service dryer receiving the high-pressure hydrogen from the one or more electrochemical hydrogen pumps; and
the on-service dryer producing dried hydrogen and fluidly connected to the off-service dryer, the on-service dryer further providing a portion of the dried hydrogen to the off-service dryer.

18. A method for regenerating an off-service dryer used in the production of hydrogen comprising:
purging the off-service dryer with an inert gas to dilute hydrogen contained in the off-service dryer; and
separating the hydrogen from the inert gas in one or more electrochemical hydrogen pumps.

19. The method of claim 18, further comprising:
stopping the purging of the off-service dryer;
directing a stream of high-pressure hydrogen into the off-service dryer; and
directing the high-pressure hydrogen from the off-service dryer to the one or more electrochemical hydrogen pumps.

20. The method of claim 19, further comprising measuring the amounts of impurities in the high-pressure hydrogen from the off-service dryer.

21. The method of claim 20, further comprising:
stopping directing the high-pressure hydrogen from the off-service dryer to the one or more electrochemical hydrogen pumps after the amount of impurities in the high-pressure hydrogen reaches a predetermined level; and
directing the high pressure hydrogen to a hydrogen utilizer.

22. The method of claim 21, wherein the predetermined level is reached when substantially no inert gas is detected in the high-pressure hydrogen.

23. The method of claim 21, wherein the amount of impurities is determined via a potentiostatic sensor.

24. The method of claim 18, wherein the inert gas comprises nitrogen, argon, or carbon dioxide.

25. The method of claim 24, wherein the inert gas comprises nitrogen.
